(19) United States
(12) Patent Application Publication
(10) Pub. No.: US 2024/0091774 A1
(43) Pub. Date: Mar. 21, 2024

(54) PASSIVE PRESSURE WAVE DAMPENER SYSTEMS

(71) Applicant: HALCYON BIOMEDICAL, INCORPORATED, FRIENDSWOOD, TX (US)

(72) Inventor: Sean Christopher Gifford, FORT EDWARD, NY (US)

(73) Assignee: HALCYON BIOMEDICAL, INCORPORATED, FRIENDSWOOD, TX (US)

(21) Appl. No.: 17/945,682

(22) Filed: Sep. 15, 2022

(51) Int. Cl. B01L 3/00

(52) U.S. Cl. CPC B01L 3/502776; B01L 3/50273; B01L 3/502753; B01L 2200/0636; B01L 2200/0652; B01L 2300/087

(57) ABSTRACT

An example system includes a passive dampener device having a chamber to hold a fluid. The passive dampener device is fluidically coupleable to a pump and a microfluidic device. The chamber has an air headspace to dampen pressure waves created by the pump in a sample fluid flow through the microfluidic device.

### BACKGROUND

Operations of microfluidic devices often rely on precisely controlled, laminar flow of fluid(s). It is often required that a pressure differential driving a fluid flow within a microfluidic device is stable. As many applications of microfluidic devices are associated with biological fluids that would ideally be kept sterile, a peristaltic pump would preferably be relied upon to drive fluid flow through the microfluidic devices. In this manner, a microfluidic system can be considered a fully closed system whose internal flow channels are kept out of contact with the surrounding atmosphere.

### SUMMARY

The present disclosure relates to passive pressure wave dampener systems. Microfluidic devices often have a liquid flow or suspension/mixture driven through one or more flow channels by a creation of a pressure gradient between an input port(s) and an output port(s) of the flow channels of the microfluidic devices. Inasmuch as the fluidic streamlines within such devices must be predictable, unchanging, and free of turbulence to enable their proper operation and optimal performance, it is often required that the pressure gradient driving the flow be stable. Many applications of microfluidic devices in particular are associated with biological fluids that would ideally be kept sterile by employing a peristaltic pump in order to drive flow through such devices as a fully closed system, kept out of contact with the surrounding atmosphere. However, the pulsatile nature of peristaltic/hose pumps and similar pumping mechanisms often generates unwanted pulses in the flow stream. To address issues that often limit the practical application of peristaltic pumps to microfluidic devices, embodiments of the present disclosure provide a single, membrane-free chamber that—due to its positioning relative to a flow path of a given microfluidic device and methods of use—serves as (1) a passive pressure pulse dampener, (2) an air bubble catcher, and (3) a clean fluid/buffer reservoir for flushing out residual sample of interest within the given microfluidic device after an input sample has been fully processed.

In one embodiment, the present disclosure provides an example passive pressure wave dampener system. An example system includes an input reservoir, a pump as defined below, a passive dampener device, and a microfluidic device. The input reservoir is configured to hold a sample. The pump is fluidically coupled to the input reservoir. The pump causes a sample fluid flow in the system. The passive dampener device is fluidically coupled to the pump. The passive dampener device is configured to dampen a pressure wave created by the pump in the sample fluid flow. The passive dampener device includes a chamber (e.g., a rigid chamber having a rigid wall or walls or a flexible chamber having a flexible wall or walls) configured to hold a fluid pressurized by the pump. The microfluidic device is fluidically coupled to the passive dampener device. The microfluidic device is configured to separate and sort a particle of interest from the sample fluid flow.

In another embodiment, the present disclosure teaches an example method for dampening a pressure wave to smoothen a pulsatile fluid flow in a microfluidic device. An example method includes pumping, via a pump, a sample from an input reservoir to form a sample fluid flow. The method further includes dampening, via a passive dampener device, pressure waves induced in the sample fluid flow by the pump. The method further includes introducing the sample fluid flow with dampened pressure waves to a microfluidic device for sample sorting.

### BRIEF DESCRIPTION OF THE DRAWINGS

The foregoing features of the present disclosure will be apparent from the following detailed description of the present disclosure, taken in connection with the accompanying drawings, in which:

FIG. 1A is a diagram illustrating an example passive pressure wave dampener system of the present disclosure;

FIG. 1B is a diagram illustrating another example passive pressure wave dampener system of the present disclosure;

FIG. 2 is a flowchart illustrating a method for dampening a pressure wave to smoothen a pulsatile fluid flow in a microfluidic device carried out by the system of the present disclosure;

FIGS. 3A-3F are diagrams illustrating priming of a passive dampener device as taught herein;

FIGS. 4A-4D are diagrams illustrating operation of an example passive dampener device for a microfluidic device of the present disclosure;

FIGS. 5A-5F are diagrams illustrating operation of an example passive dampener device for flushing a microfluidic device post processing of the present disclosure;

FIG. 6 is a diagram illustrating an example microfluidic device;

FIG. 7A is a graph graphically illustrating a pressure wave over a time period for a microfluidic device without using a passive dampener device of the present disclosure;

FIG. 7B is a graph graphically illustrating pressure wave dampening over a time period for a microfluidic device using a passive dampener device of the present disclosure;

FIG. 7C is a diagram schematically illustrating a particle flow streamline along a flow path due to the pressure changes graphed in FIG. 7A;

FIG. 7D is a diagram schematically illustrating a particle flow streamline along a flow path due to the pressure changes graphed in FIG. 7B;

FIGS. 8A-8C are frames from a video illustrating flow lines of cells in a microfluidic device without a passive dampener device of the present disclosure; and

FIGS. 8D-8F are frames from a video illustrating flow lines of cells in a microfluidic device with a passive dampener device of the present disclosure.

### DETAILED DESCRIPTION

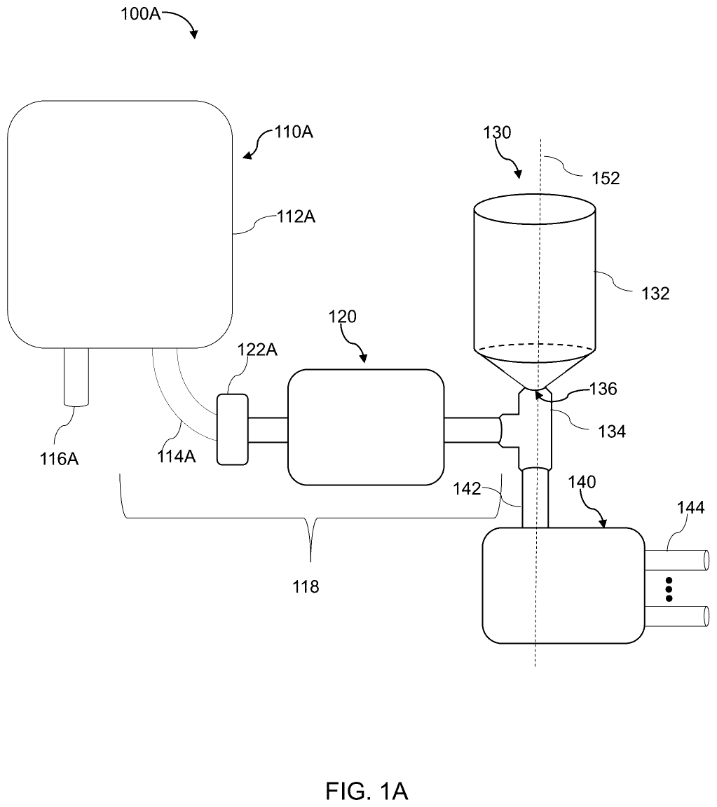

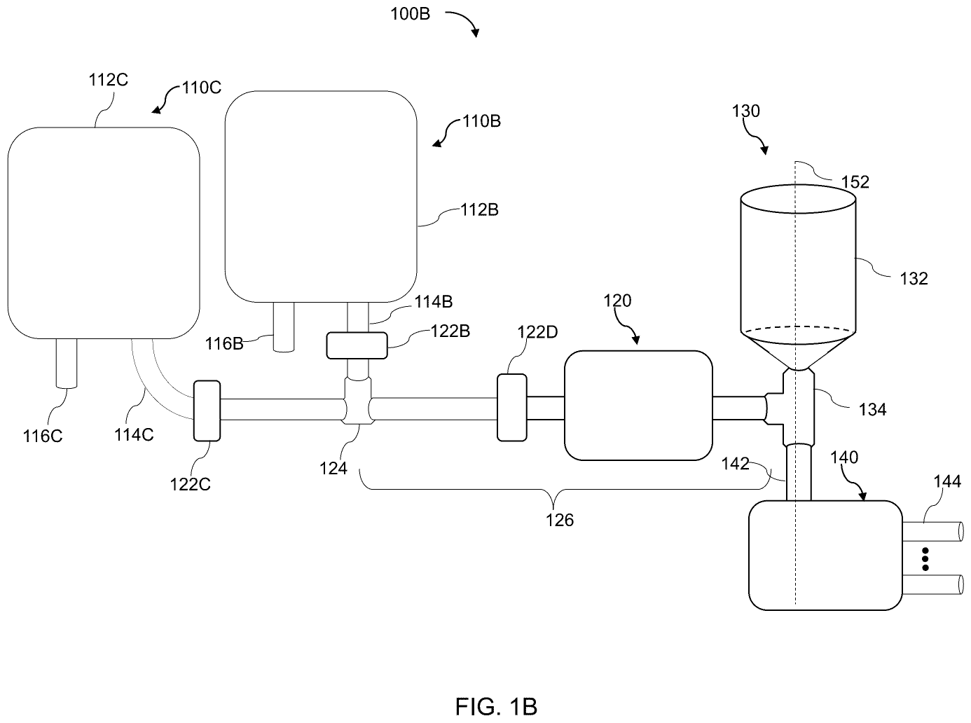

The present disclosure relates to passive pressure wave dampener systems. Example systems and methods are described in detail below in connection with FIGS. 1-8.

Operation of microfluidic devices often rely on precisely controlled, laminar flow of fluid(s). For example, a microfluidic device can often transport particular cells or particles of interest in a fluid suspension through a network of channels, which may or may not contain obstacles, bifurcations, or other features employed to effectuate a separation or sorting of said cells/particles as the fluid suspension is driven through such a device. To ensure predictable/laminar fluidic streamlines, a pressure differential between an input of the microfluidic device and one or more outputs of the microfluidic device, which drives a flow of fluid, must be essentially non-pulsatile and stable. The pressure differential can be created by simple gravity/hydrostatic pressure, a syringe pump, or other means of producing a compressive force on an input sample and/or a headspace above the input sample. These pressure differential creation approaches are often used with microfluidic and/or other flow-through devices in order to achieve an acceptably stable flow, which allows cell separation features within the microfluidic and other flow-through devices to function as intended. Stable fluid dynamics within the microfluidic and/or other flow-through devices also minimizes shear stress on a flowing sample, which in many cases may contain blood cells and/or other biological material that is inherently susceptible to damage or activation caused by elevated shear stress.

Unfortunately, both gravity-driven and syringe-driven fluid pressurization approaches suffer from drawbacks that limit their usefulness in practice. For example, it is difficult to achieve more than a few feet of hydrostatic pressure (i.e., about 2-3 pounds per square inch (PSI)) if using gravity/height alone. In addition, many applications of microfluidic devices are associated with biological fluids that must be kept sterile. However, because a large portion of the inside of a syringe barrel of a standard syringe ‘touches’ the surrounding air when the syringe is initially empty, a standard syringe is by nature a non-sterile system unless it is used in a fully sterile environment such as a biocontainment hood or cleanroom, which limits its utility for applications requiring sample sterility. Further, there are upper limits to how much fluid a syringe can hold. Syringe pumps are often not capable of handling syringes larger than 60 milliliters (mL), in rare cases up to 120 mL, in volume. These limitations are particularly restrictive in applications involving biological samples such as blood cell suspensions, in which several hundred milliliters of an input sample may need to be processed and kept completely sterile while driven through a microfluidic device.

While alternative approaches have been developed to sterilely drive blood cell samples through microfluidic devices, a particularly desirable method for creating a pressure differential across a microfluidic device is the use of a peristaltic pump, which functions completely external to the sample itself. The peristaltic pump acts only upon an outer surface of a tubing that connects an input sample to a microfluidic device. The input sample can be often housed in a container (e.g., a flexible bag or other closed container). However, the peristaltic pump unfortunately creates a series of pressure waves with each revolution of the rotating pump-head of the peristaltic pump, as its rollers drive fluid through the tubing. These pressure waves typically render peristaltic pumping unsuitable for driving flow through microfluidic devices.

Two additional practical considerations associated with the use of microfluidic devices are (i) catastrophic results that can occur if one or more flow channels become occluded with an air bubble, as precise/uninterrupted flow conditions are often essential to proper functioning of a microfluidic device, and (ii) an ability to flush the dead volume (as defined below) of a microfluidic device at the conclusion of processing of an input sample, as in many cases it is desirable to minimize a loss of cells or particles of interest within the channels of the microfluidic device itself and/or within its attendant tubing connections.

To address issues that often limit the practical utility of microfluidic devices, embodiments of the present disclosure provide a single, membrane-free chamber that—due to its positioning relative to the flow path of a given microfluidic device and methods of use—serves as a (1) passive pressure pulse dampener, (2) air bubble catcher, and (3) clean fluid/buffer reservoir for flushing out residual sample within the given microfluidic device after an input sample has been fully processed via a peristaltic, or other pulsatile, pumping mechanism as described with respect to FIGS. 1-8.

As used herein, a “pump” refers to a device that moves fluids (liquids, suspensions, or gases) in a pulsating manner. Examples of a pump can include a peristaltic pump, a pulsatile pump or other pump that creates pulses in fluids moved by the pump.

As used herein, “passive pressure wave dampener” refers to a dampening system/device/component that operates without electrical power to dampen pressure waves in a fluid flow.

As used herein, a “chamber” refers to a container having a rigid wall(s) or a flexible wall(s) for holding a fluid.

As used herein, a “dead volume” refers to an internal volume in a microfluidic device and its attendant tubing.

As used herein, a “pulse volume” refers to a volume delivered by a pump-head per a periodic pulse generated by a rotation or other mechanism of a pump.

### Passive Pressure Wave Dampener System

Turning to the drawings, FIG. 1A is a diagram illustrating an example passive pressure wave dampener system 100A of the present disclosure. The passive pressure wave dampener system 100A is a fully closed system providing a sterile environment for biological/biomedical applications.

The passive pressure wave dampener system 100A includes an input reservoir 110A, a pump 120, a passive dampener device 130, and a microfluidic device 140.

The input reservoir 110A is configured to provide an input liquid mixture, such as a priming fluid (e.g., aqueous fluid or buffer) and/or an input sample having a plurality of particles or cells in a fluid (e.g., particulate or cellular suspension), to the microfluidic device 140. The input reservoir 110A includes a container 112A, an input channel or inlet 116A, an output channel or outlet 114A, a flow path 118, and in some embodiments a valve or clamp 122A.

The container 112A (e.g., a flexible bag or any other suitable container) is configured to hold the input liquid mixture. The input channel or inlet 116A is configured to introduce the liquid mixture, which in some embodiments may be performed via sterile tubing weld to one or more bags containing the fluid(s) to be processed, and the output channel or outlet 114A is configured to is in communication with the pump 120. The flow path 118 fluidically couples the input reservoir 110A, the pump 120, the passive dampener device 130, and the microfluidic device 140. The valve or clamp 122A may be used to control a fluid flow entering the pump 120. In some embodiments, multiple input reservoirs can be used as further described with respect to FIG. 1B.

The pump 120 is configured to pump/pressurize the liquid mixture. The pump 120 can be in communication with tubing forming a portion of the flow path 118 by compressing the flow path 118 in such a manner that the liquid mixture is pressurized, thereby causing a pulsatile output fluid flow from the pump 120. For example, a peristatic pump can compress the flow path 118 as the flow path 118 is acted upon by two or more rotating rollers of the peristatic pump-head 120. Other pulsatile, pumping mechanisms can be used to pump/pressurize the liquid mixture.

The passive dampener device 130 is configured to dampen the series of pressure waves created by the pump 120 in a pulsatile fluid flow in order to smoothen the pulsatile fluid flow. The passive dampener device 130 is disposed downstream of the pump 120 and upstream of the microfluidic device 140. The passive dampener device 130 is external to the pump 120 and microfluidic device 140.

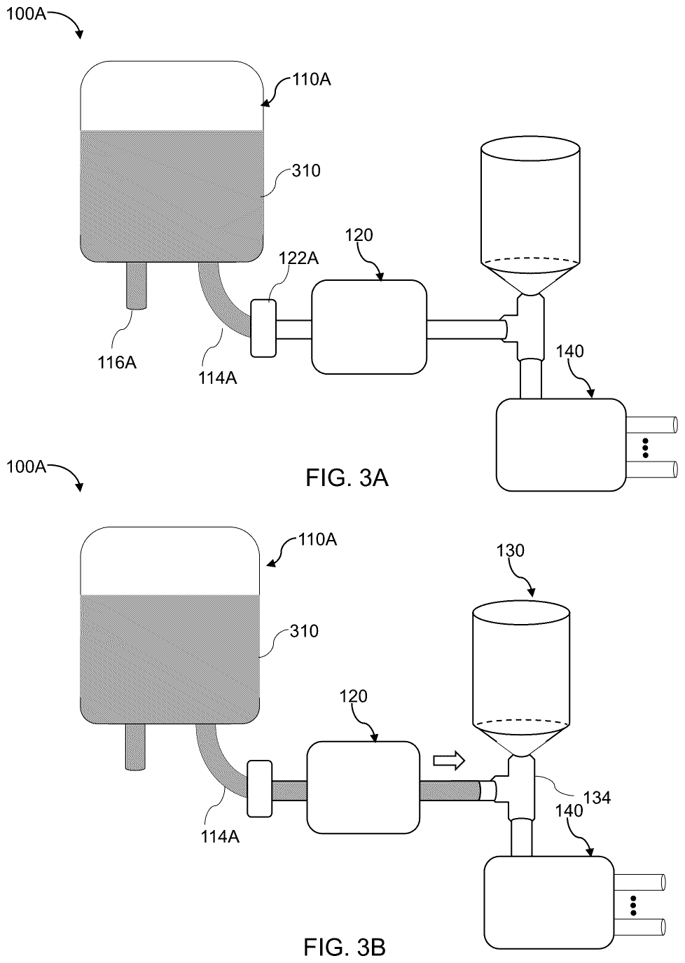

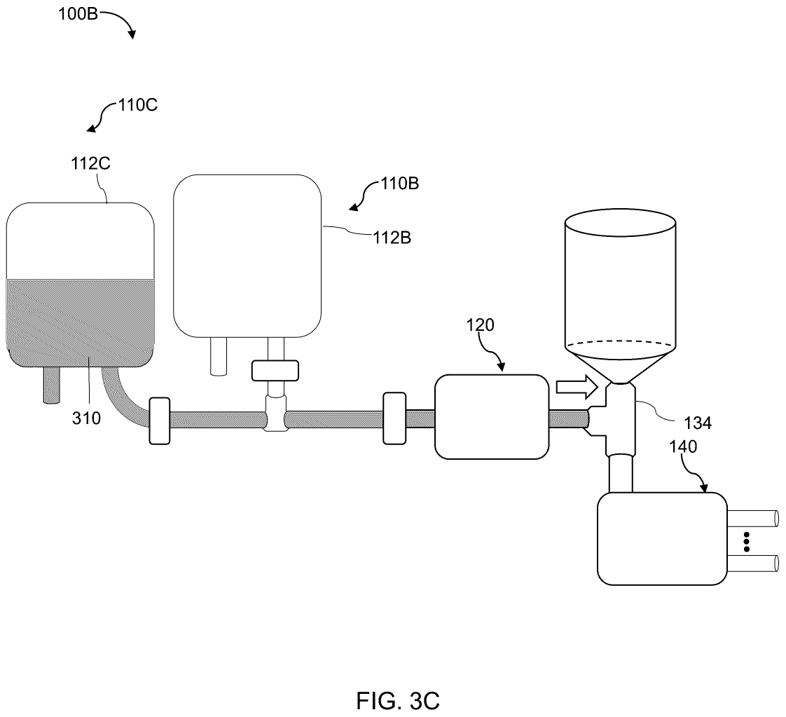

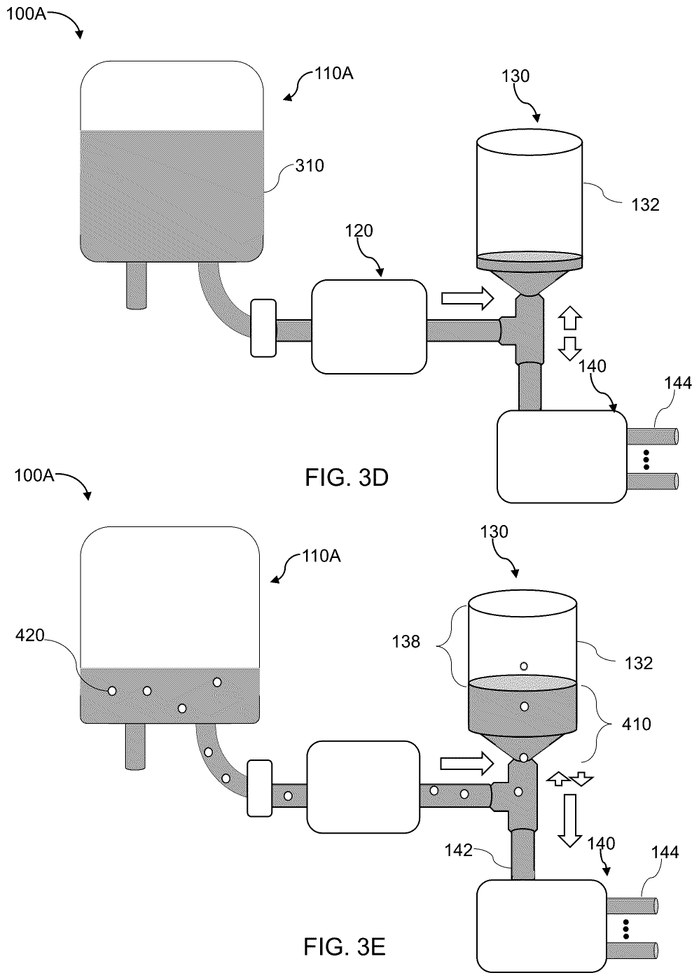

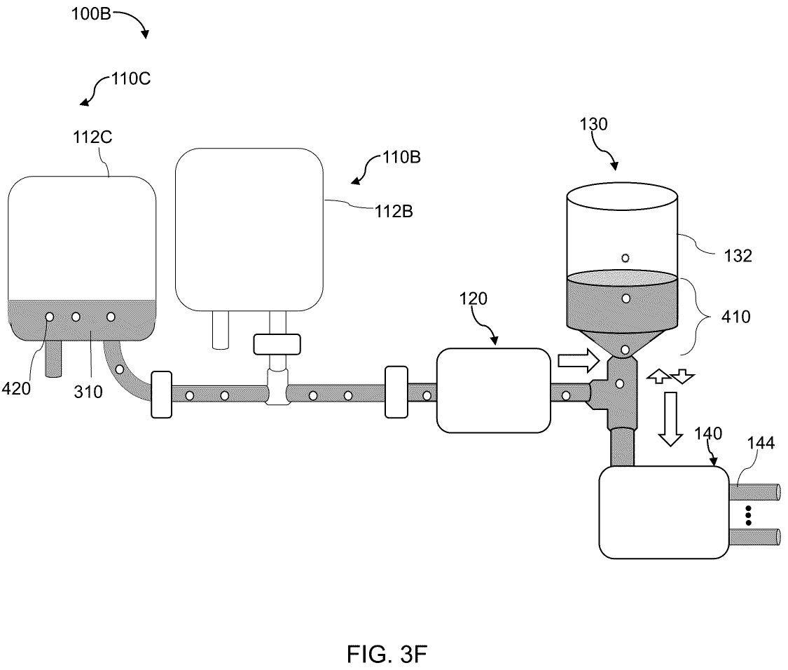

The passive dampener device 130 includes a chamber 132 and a connector 134 (e.g., a T connector). The chamber 132 is configured to hold fluid pressurized by the pump 120. The chamber 132 includes a port 136. Examples of the chamber 132 can include a rigid walled chamber, a flexible walled chamber or any other suitable chamber configured to contain fluid and/or air. The connector 134 is configured to fluidically couple the chamber 132 (e.g., via the port 136), the pump 120 (e.g., via the flow path 118), and the microfluidic device 140 (e.g., via an inlet 142). When the passive dampener device 130 is partially filled by a pressurized fluid, the chamber 132 includes an air headspace 138 (shown in FIG. 3E) pressurized by the pump.

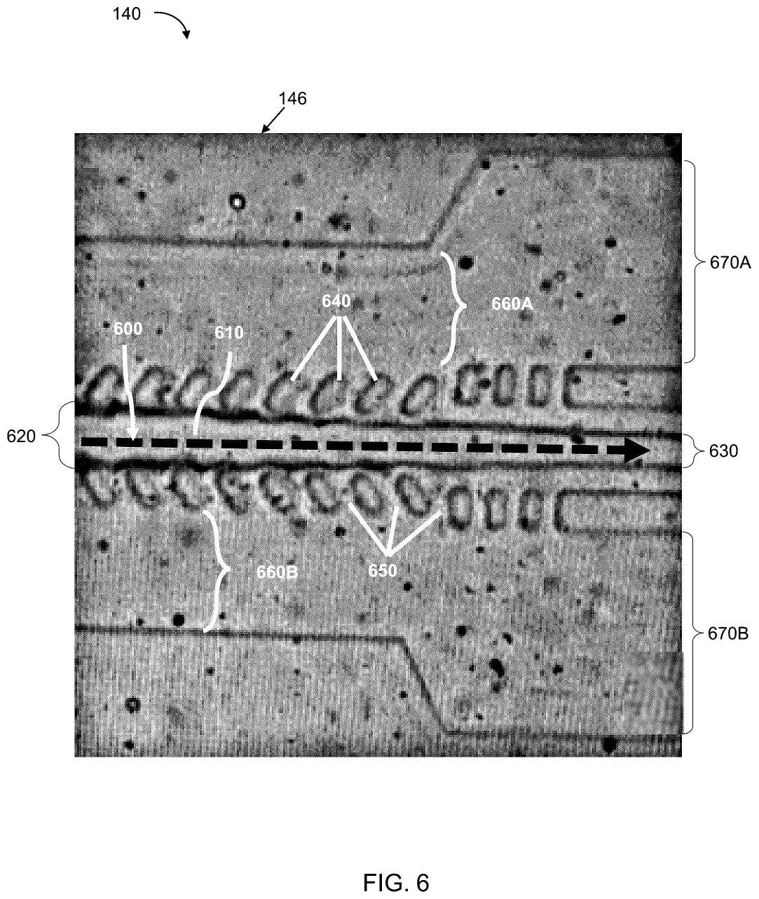

The microfluidic device 140 is configured to process (e.g., perform cell separation or sorting, or other operations, on) the input sample provided by the input reservoir 110A. The microfluidic device 140 includes an inlet 142, two or more outlets 144, and a flow path (e.g., shown in FIGS. 6-8) from the inlet 142 to the two or more outlets 144. The inlet 142 is fluidically coupled to the connector 134. An example microfluidic device 140 is further described with respect to FIGS. 6-8.

FIG. 1B is a diagram illustrating another example passive pressure wave dampener system 100B of the present disclosure. The passive pressure wave dampener system 100B includes two input reservoirs 110B and 110C, a connector 124, a flow path 126, a valve or clamp 122D, the passive dampener device 130, and the microfluidic device 140.

The input reservoir 110B is configured to hold and provide an input sample. The input reservoir 110B includes the container 112B, the input channel or inlet 116B, the output channel or outlet 114B, and the valve or clamp 122B. The container 112B holds the input sample. The output channel or outlet 114B outputs the input sample into the flow path 126. The valve or clamp 122B is used to control a fluid flow entering the connector 124.

The input reservoir 110C is configured to hold and provide a priming fluid. The input reservoir 110C includes the container 112C, the input channel or inlet 116C, the output channel or outlet 114C, and the valve or clamp 122C. The container 112C holds the priming fluid. The output channel or outlet 114C outputs the priming fluid into the flow path 126. The valve or clamp 122C is used to control a fluid flow entering the connector 124.

The connector 124 is fluidically couple to the input reservoir 110B, the input reservoir 110C, and the flow path 126. The flow path 126 fluidically couples the input reservoirs 110B and 110C (e.g., via the connector 124), the pump 120, the passive dampener device 130 (e.g., via the connector 134), and the microfluidic device 140 (e.g., via the connector 134 and inlet 142). The valve or clamp 122D is used to control a fluid flow entering the pump 120.

As can be seen in FIGS. 1A and 1B, the connector 134 of the passive dampener device 130 is in fluidic communication with the input reservoirs 110A-110C, the chamber 132, the pump 120, and the microfluidic device 140.

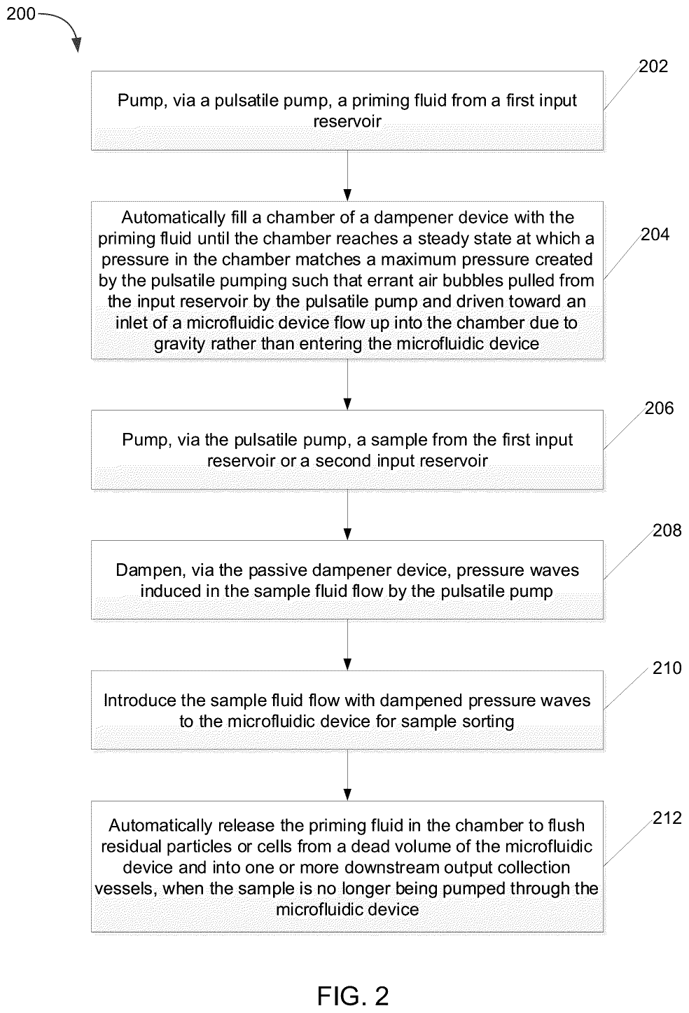

The chamber 132 can be disposed in an orientation such that errant air bubbles pulled from the input reservoir(s) 110A-110C by the pump 120 and driven toward the inlet 142 of the microfluidic device 140 can flow up into the chamber 132 due to gravity, rather than entering the microfluidic device 140. Further, the pressurized fluid in the chamber 132 acts to push residual particles or cells through the microfluidic device 140 when the sample from the input reservoir(s) 110A-110C is no longer being pumped through the microfluidic device 140 (e.g., when the pump 120 is turned off once the input reservoir 110A/110B has been emptied to the desired degree), as further described with respect to FIG. 2.

In preferred embodiments, while the system is in operation the chamber 132 may be disposed such that a longitudinal axis 152 of the chamber 132 and the connector 134 is directed approximately toward the center of the Earth (e.g., along the direction of gravity) and/or in operation the longitudinal axis 152 is substantially perpendicular to the microfluidic device 140.

The size of the chamber 132 can be calculated based at least in part on the type of the pump, the pressure range of a pressure wave produced by the pump, the volume of the chamber to be filled, and the volume per periodic pulse generated by the pump as further described with respect to the Section of “Passive Dampener Volume Calculation.”

The passive pressure wave dampener system 100A or 100B can serve as (1) an effective passive pulse dampener of pressure waves arising from the pump 120 that drives flow of the particulate/cellular sample from the input reservoirs 110A-110C through the microfluidic device 140, (2) a ‘bubble catcher’ to divert and incorporate any unwanted air that may otherwise flow into, and confound operation of, the microfluidic device 140, and (3) a reservoir of clean fluid/buffer to be used to flush residual particulates/cells through the microfluidic device 140 following the desired degree of emptying of the input reservoirs 110A-110C, as further described in FIGS. 3-5.

FIG. 2 is a flowchart illustrating a method 200 for dampening of pressure waves to smoothen a pulsatile fluid flow in a microfluidic device 140 carried out by the system of the present disclosure.

In step 202, the pump 120 pumps a priming fluid from a first input reservoir. For example, the input reservoir 110A shown in FIG. 1A initially contains the priming fluid (e.g., aqueous fluid/buffer) with which to prime the microfluidic device 140. In another example, the input reservoir 110C shown in FIG. 1B contains the priming fluid to prime the microfluidic device 140. The priming fluid is then pumped out of the input reservoir 110A or 110C at a given flow rate. Examples are described with FIGS. 3A-3C.

In step 204, the chamber 132 automatically fills with the priming fluid pumped out of the input reservoir 110A or 110C until the chamber 132 reaches a steady state at which a pressure in the chamber 132 matches a maximum pressure created by the pump 120. Errant air bubbles can be pulled from the input reservoir 110A or 110C by the pump 120 and driven toward the inlet 142 of the microfluidic device 140 and flow up into the chamber 132 due to gravity rather than entering the microfluidic device 140.

The two or more outlets 144 of the microfluidic device 140 can be occluded (e.g., via clamping) to allow a resulting increase in pressure within the microfluidic device 140 to raise the air solubility of the priming fluid, thereby increasing the dissolution rate of any air that had been trapped within the microfluidic device 140 during priming. Examples are described with FIGS. 3D-3F. Occlusion of the outlets 144 may also be desired to prevent dampener emptying during the finite time necessary to switch from priming fluid to input sample.

In step 206, the pump 120 pumps a sample (e.g., a particulate/cellular suspension of interest) from the first input reservoir or a second input reservoir. For example, a sample can be injected, or introduced via a sterile tubing weld, into the input reservoir 110A shown in FIG. 1A. In another example, a sample can be injected, or introduced via a sterile tubing weld, into the input reservoir 110B shown in FIG. 1B. The sample is then pumped out of the input reservoir 110A or 110B at a given flow rate.

In step 208, the passive dampener device 130 dampens pressure waves induced in the sample fluid flow by the pump 120. The pump 120 can cause a sample fluid flow in the system and create a pressure wave in the sample fluid flow. The passive dampener device is disposed downstream of the pump and upstream of the microfluidic device.

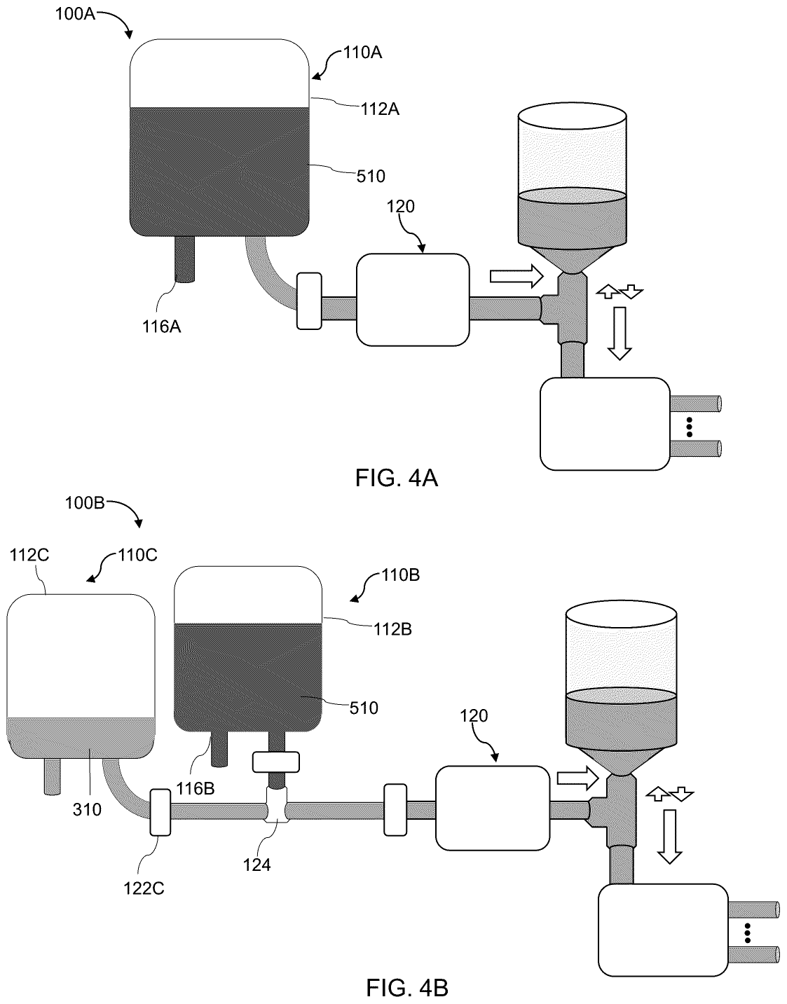

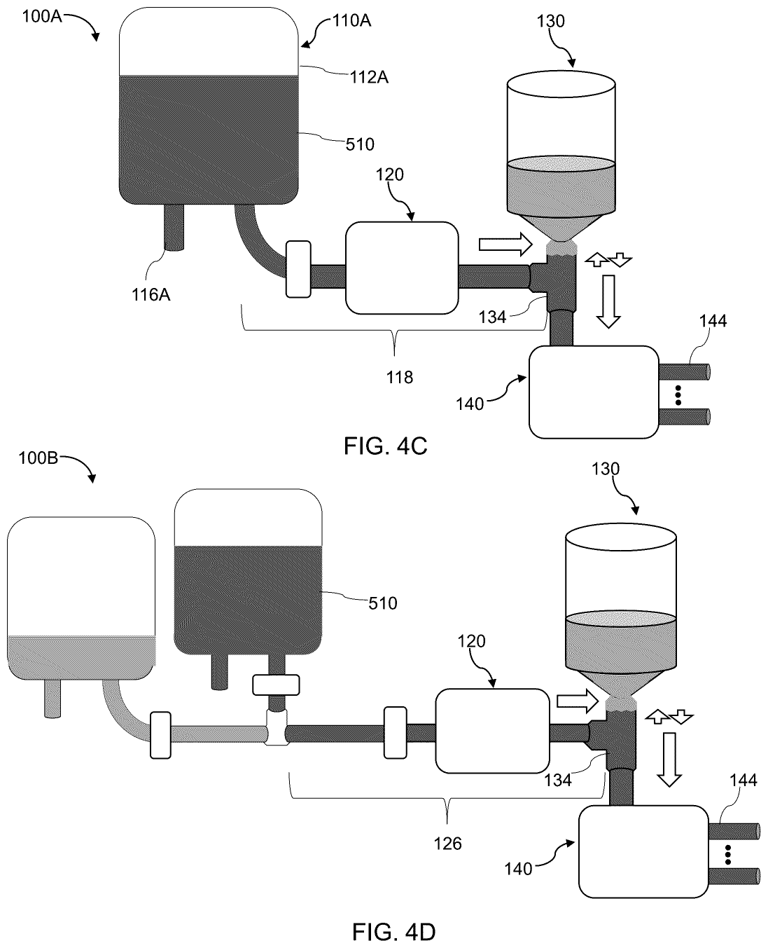

In step 210, the sample fluid flow with dampened pressure waves is introduced to the microfluidic device 140 for sample sorting. The outlets 144 of the microfluidic device 140, if previously occluded, will have been opened, and the sample can be driven though the microfluidic device 140. As the chamber 132 has reached the steady state during the priming stage described in steps 202 and 204, the sample (having particulates/cells with a density higher than that of water) are completely or almost completely directed into the microfluidic device 140 instead of being diverted into the chamber 132. Any small amount of sample diverted to the dampening chamber 132 during pumping would largely be expelled and driven through the downstream device once the pumping mechanism is halted during step 212. Examples are described with FIGS. 4A-4D.

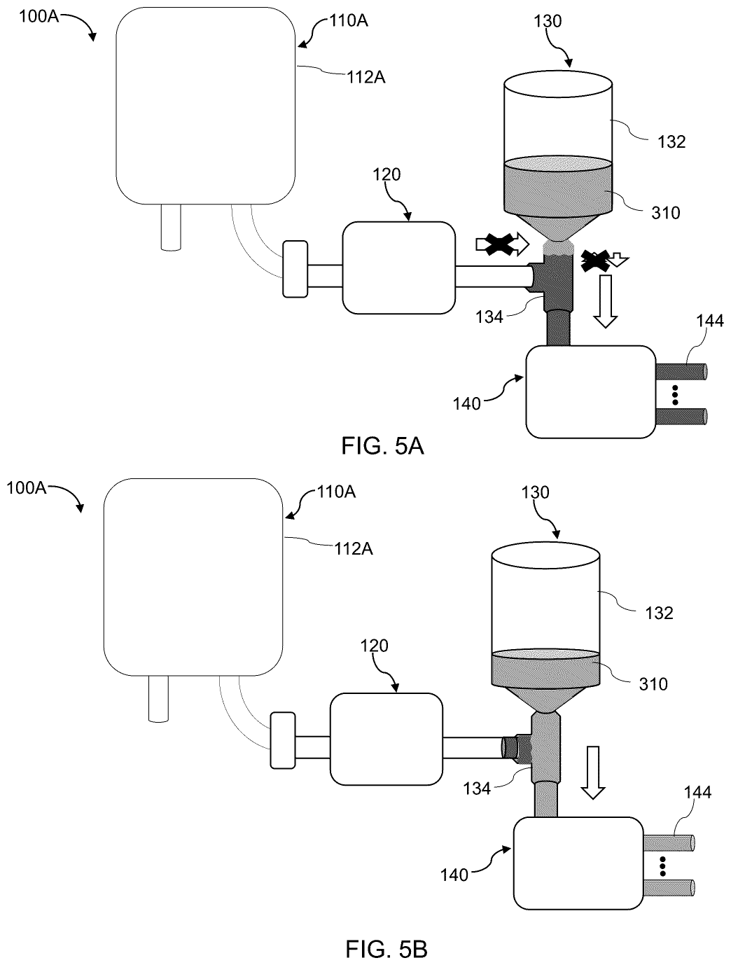

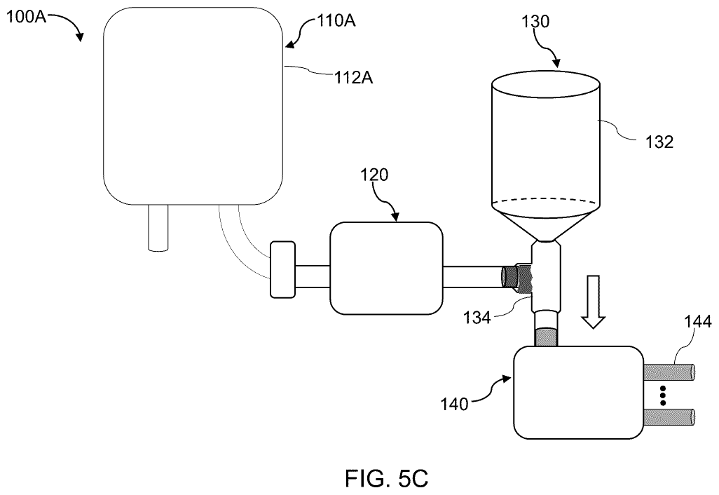

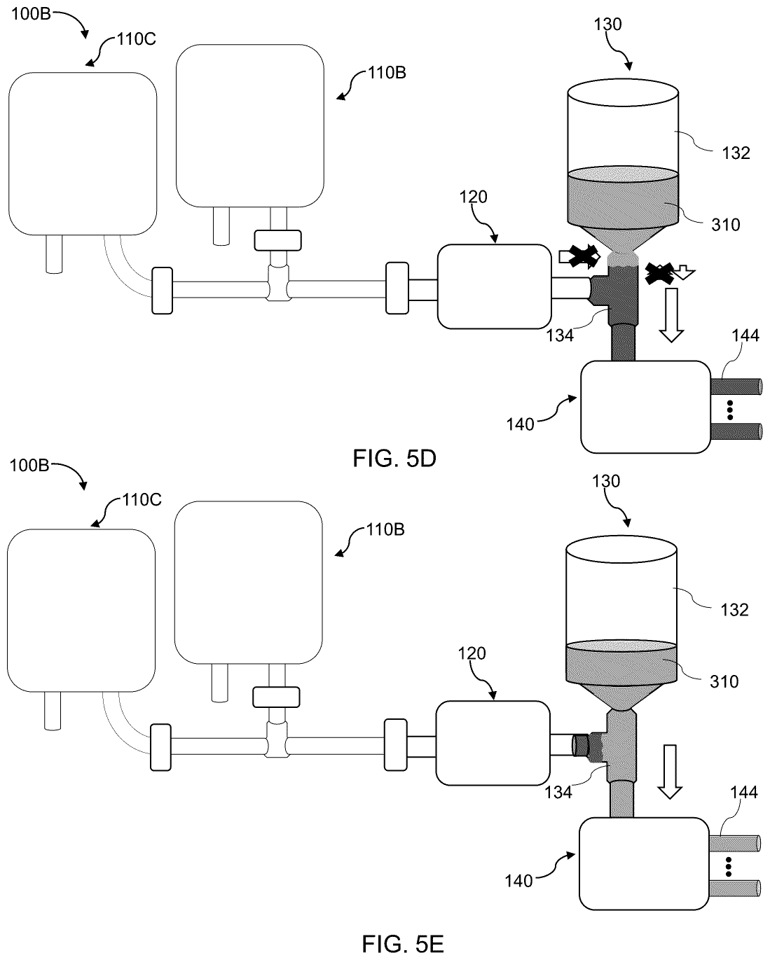

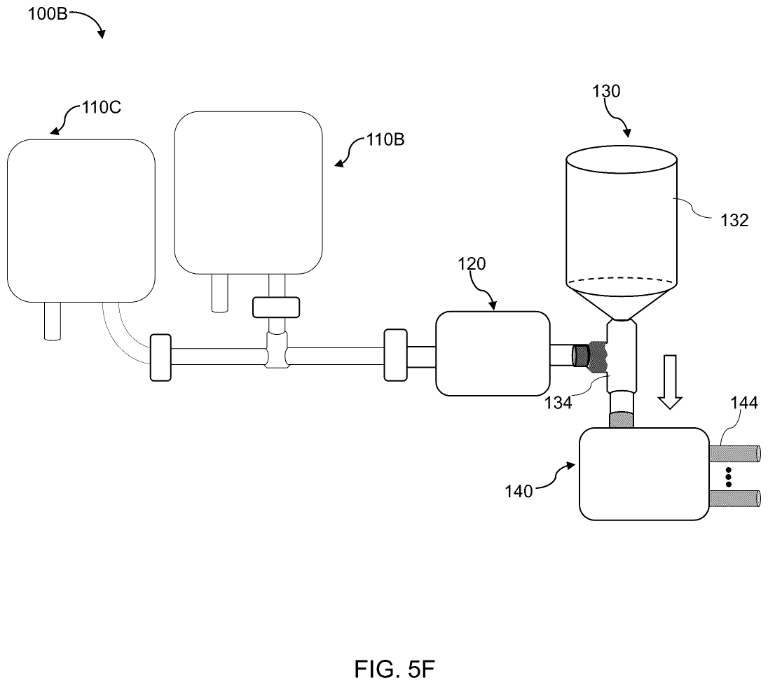

In step 212, when the sample is no longer being pumped through the microfluidic device 140, the chamber 132 automatically releases the priming fluid to flush residual particles or cells from the dead volume of the microfluidic device 140 and into one or more downstream output collection vessels (not shown) via the outlets 144 of the microfluidic device 140. Examples are described with FIGS. 5A-5F.

FIGS. 3A-3F are diagrams illustrating priming of a passive dampener device 130 as taught herein. As shown in FIG. 3A, the input reservoir 110A is initially filled with a priming fluid 310 to prime the microfluidic device 140. The output channel 114A can be blocked by the valve or clamp 122A before the priming fluid 310 is pumped/pressurized by the pump 120. As shown in FIG. 3B, the priming fluid 310 is then pumped/pressurized out of the input reservoir 110A by the pump 120 at a given flow rate toward the connector 134. As shown in FIG. 3C, in embodiments that include two input reservoirs or containers, one of the containers can be filled with the priming fluid. For example, the container 112C contains the priming fluid 310. The priming fluid 310 is then pumped/pressurized out of the input reservoir 110C by the pump 120 at a given flow rate toward the connector 134. In FIG. 3D, the chamber 132 begins to fill with the priming fluid 310 pumped/pressurized by the pump 120 via the connector 134. Initially the pressurized priming fluid 310 flows both up into the chamber 132 and down into/through the microfluidic device 140. As shown in FIG. 3E, the chamber 132 reaches a steady state that refers to a state at which a pressure in the chamber 132 matches the maximum pressure created by the pump 120 such that a volume 410 of the chamber 132 that has been filled by the pressurized priming fluid 310 becomes steady other than the fluctuations caused by the pulsatile nature of the pump 120.

The passive dampener device 130 can serve as an air bubble catcher. For example, during and after this priming stage, any errant air bubbles 420 that may be pulled from the input reservoir 110A by the pump 120 and driven toward the inlet 142 of the microfluidic device 140 will flow up into the chamber 132 due to gravity, rather than entering the microfluidic device 140. The errant air bubbles 420 are trapped within the chamber 132, merging with the air of its headspace 138. As shown in FIG. 3F, in the embodiment in which the input reservoirs 110B and 110C are used, similar to FIG. 3E, the chamber 132 reaches a steady state at which a pressure in the chamber 132 matches the maximum pressure created by the pump 120 such that the volume 410 of fluid in the chamber reaches a steady state of pressurization, with associated fluctuations. Any errant air bubbles 420 pulled from the input reservoir 110 by the pump 120 and driven toward the inlet 142 of the microfluidic device 140 flow up into the chamber 132 due to gravity rather than entering the microfluidic device 140.

FIGS. 4A-4D are diagrams illustrating operation of the passive dampener device 130 and microfluidic device 140 during sample processing. As shown in FIGS. 4A and 4B, once the system 100A/100B is primed, a sample 510 (e.g., a particulate/cellular suspension of interest) can be injected into the container 112A/112B using the input channel 116A/116B or input via sterile tubing weld (not shown). As shown in FIG. 4B, in embodiments with two or more input containers, one container 112C maintains the priming fluid while the other container(s) 112B are filled with the sample, for example, the container 112C maintains the priming fluid 310 and the valve or clamp 122C can be used to block the priming fluid 310 from entering the connector 124. The sample 510 can be injected into the container 112B using the input channel 116B or input via sterile tubing weld (not shown). As shown in FIGS. 4C and 4D, the sample 510 is pumped by the pump 120 via the flow path 118/126 and subsequently flows into the connector 134 of the passive dampener device 130. The outlets 144 of the microfluidic device 140 carry the sample 510 that has been driven though, and processed by, the microfluidic device 140 to one or more collection vessels (not shown). As the chamber 132 has reached steady state during the priming stage described in steps 202 and 204 of FIG. 2 and FIGS. 3A-3F, the sample 510 (having particulates/cells with density higher than that of water) are completely or almost completely directed into and through the microfluidic device 140 instead of being diverted into the chamber 132.

FIGS. 5A-5F are diagrams illustrating operation of the passive dampener device 130 for flushing the microfluidic device 140 after processing the desired amount of sample. As shown in FIGS. 5A-5C, the sample 510 is no longer being pumped through the microfluidic device 140. For example, when the pump 120 is turned off, the sample 510 is not pumped into the microfluidic device 140. When the sample 510 is no longer being pumped through the microfluidic device 140, the priming fluid 310 within the chamber 132 then automatically begins to flow through the microfluidic device 140 (e.g., flowing down into and through the microfluidic device 140) to flush residual particles or cells from the dead volume of the microfluidic device 140 and into one or more downstream output collection vessels (not shown) via the outlets 144. As shown in FIGS. 5D-5F, in the embodiments in which multiple input reservoirs 110B and 110C, similar to FIGS. 5A-5C, the chamber 132 automatically releases the priming fluid 310 to flush residual particles or cells from a dead volume of the microfluidic device 140 and into one or more downstream output collection vessels (not shown), when the sample 510 is no longer being pumped through the microfluidic device 140.

The pump (e.g., a peristaltic/hose pump) can be used in a sterile environment, because the pump can provide a mechanism to drive unlimited amounts of input sample for device processing in a manner that maintains the sterility of a sterile input sample, provided that the interior of the input reservoir (e.g., the input reservoirs 110A-110C in FIGS. 1-5), the interior of the passive dampener device (e.g., the passive dampener device 120 in FIGS. 1-5), the fluid contact portions of the microfluidic device (e.g., the microfluidic device 140 in FIGS. 1-5) and associated tubing have been sterilized prior to their use.

### Passive Dampener Volume Calculation

A size of a passive dampening chamber (e.g., the chamber 132 in FIGS. 1-5) can be chosen in order to dampen pressure waves created by a pump (e.g., the pump 120 in FIGS. 1-5).

One skilled in the art will appreciate that peristaltic pumps can have a known number of rollers which are spaced a known distance apart around a circular pump-head. These dimensions along with knowledge of the internal diameter of the tubing that is being periodically squeezed by the pump-head rollers, to generate a peristaltic flow, allows for a calculation of the so-called ‘pulse volume’ (as defined above) of a pump/tubing combination. In general, the larger the pulse volume the larger the amplitude of the pressure waves generated by the pump, and the larger the amount of trapped/pressurized air that needs to be housed by the dampening chamber of the present disclosure.

In general, if one knows a degree of pressure variation that occurs in a system (with a given pump, passive dampener device, and microfluidic device), in which a system pressure varies between a minimum pressure (Pₘᵢₙ) and a maximum pressure (P max), and a dampening chamber total volume is V_{d} when the dampening chamber is empty, and the dampening chamber is filled to a fraction of f_{filled} during operation of the particle processing system, a common, isentropic process assumption is made in which a ‘pump dampener factor’ f_{d} (e.g., a constant associated with a given type of a pump) for the system can be calculated using the Equation (1) as follows:

$$\\ \begin{matrix}{f}_{d} = \frac{{V}_{d} * {f}_{filled} * [ 1 - {( \frac{{P}_{min}}{{P}_{max}} )}^{\frac{1}{n}} ]}{{V}_{p}} & ( 1 )\end{matrix}$$

Where Vₚ is a pulse volume (e.g., a fluidic volume per periodic pulse generated by the associated pump), and n is a constant that is specific to the gas being used within such a dampener (e.g., for air or nitrogen at room temperature, n≈1.4).

Different pumps generally show different values of f_{d}. Based on available literature, values of several pump types are shown in the table below, with ‘hose pump’ a synonym of peristaltic pump:

| Type of pump | Factor |
|---|---|
| Single-shoe/roller hose pump | 0.87 |
| Two-shoe hose pump | 0.73 |
| Air-operated double diaphragm pump | 0.19 |
| Simplex single acting | 0.60 |
| Triplex single acting | 0.13 |
| Quadruplex single acting | 0.10 |
| Quintuplex single acting | 0.06 |

Syringe pumps may also benefit from the use of the present disclosure, though their degree of pressure fluctuation (due to intermittent operation of a stepper motor compressing the syringe) is often significantly smaller than that of peristaltic pumps, and therefore when using a syringe-based pumping approach a correspondingly-smaller dampening chamber can be employed.

Once a pump dampener factor f_{d} is known for a given pump, the known f_{d} value can be used to estimate the total volume V_{d} of the passive dampening chamber that can be used in the same system to generate an acceptably small pressure variation, ΔP, to ensure acceptable performance of the downstream microfluidic device. The total volume V_{d} of a passive dampening chamber can be calculated using the Equation (2) as follow:

$$\\ \begin{matrix}{V}_{d} = \frac{{V}_{p} * {f}_{d} * {( \frac{{P}_{min} + Δ P}{{P}_{min}} )}^{\frac{1}{n}}}{{f}_{filled} * [ {( \frac{{P}_{min} + Δ P}{{P}_{min}} )}^{\frac{1}{n}} - 1 ]} & ( 2 )\end{matrix}$$

In practice, however, due to the aforementioned complexities in a given pump/device system setup, some degree of trial and error may be needed to determine an appropriately-sized passive dampener for a given application.

### Use Case

For a microfluidic device intended to separate/filter cells in a flowing suspension by size, in which individual device output tubing effluent streams are intended to carry different-sized cell cohorts to corresponding collection vessels, any pressure fluctuations may cause unwanted mixing of the fluidic streams carrying cells of different sizes (or one or more cell-free streams), particularly near the exit of the microfluidic device. The passive dampener device taught herein can dampen fluidic sample pressure waves to reduce or eliminate such unwanted mixing such that cells within the sample can be properly sorted by the internal channels of the microfluidic device, as described with respect to FIGS. 6-8.

FIG. 6 is a diagram illustrating a portion 146 of one channel within an example microfluidic device 140. The portion 146 of the microfluidic device 140 includes a central channel 610 extending along a flow path 600 of the microfluidic device 140 between a central channel flow input 620 (e.g., the inlet 142 in FIGS. 1-5) and a central channel flow output 630 (e.g., one of the two or more outlets 144 in FIGS. 1-5). The portion 146 of the microfluidic device 140 further includes a plurality of micro-features 640 adjacent to the central channel 610. The plurality of micro-features 640 are longitudinally disposed along both sides of the central channel 610. The plurality of micro-features 640 define a plurality of gaps 650 and separate the central channel 610 from a first side channel 660A and a second side channel 660B. The plurality of gaps 650 are configured to fluidically couple the central channel 610 to the first and second side channels 660A/660B. The first and second side channels 660A/660B extend longitudinally along the central channel 610 to a first side channel output 670A and a second side channel output 670B, respectively.

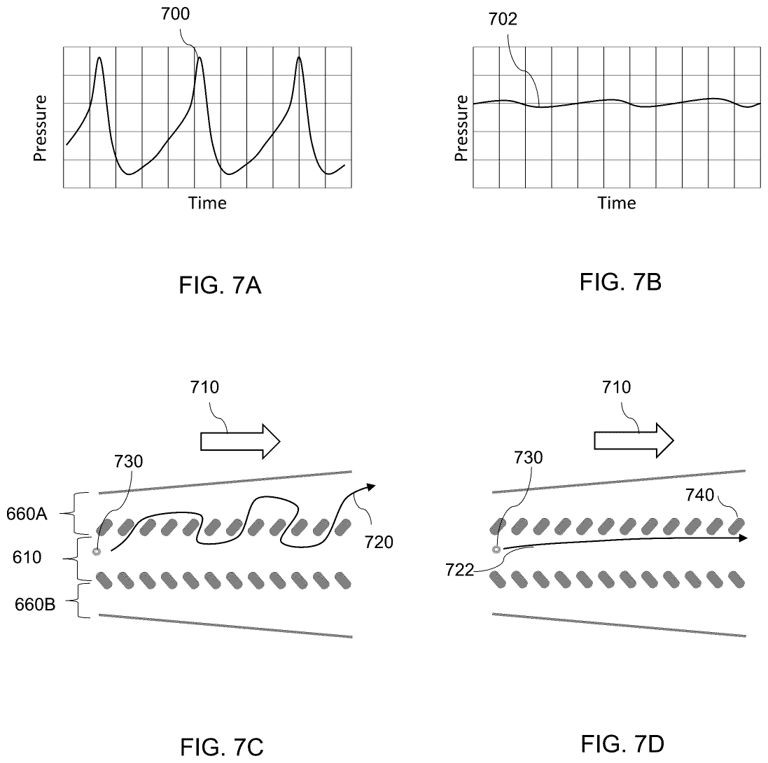

FIG. 7A is a graph illustrating a pressure change over a time period for the microfluidic device 140 without using the passive dampener device 130 of the present disclosure. FIG. 7B is a graph illustrating a pressure dampening over a time period for the microfluidic device 140 using the passive dampener device 130 of the present disclosure. FIG. 7C is a diagram schematically illustrating a particle flow streamline 720 along a flow path 710 due to the pressure changes graphed in FIG. 7A. FIG. 7D is a diagram schematically illustrating a particle flow streamline 722 along a flow path direction 710 due to the pressure changes graphed in FIG. 7B;

As shown in FIGS. 7A and 7C, there is a pressure fluctuation 700 caused by the pump 120 in the microfluidic device 140, which causes unwanted mixing of the fluidic streams carrying cells of different sizes (or one or more cell-free streams), particularly near the exit of the microfluidic device 140. For example, the cell 730 preferably would remain confined in the central channel 610, in the case of a microfluidic device 140 in which this particular flow path was designed to retain cells of the size of cell 730 in its central channel 610. Due to the pressure fluctuation 700 caused by the pump 120, the cell 730 moves in and out between the central channel 610 and the side channel 660A. The cell 730 eventually moves out from the central channel 610 into the side channel 660A and exits from side channel 660A, which causes an error in sorting.

As shown in FIGS. 7B and 7D, by using the passive dampener device 130 to dampen pressure waves created by the pump 120, a pressure fluctuation 702 in the microfluidic device 140 is greatly reduced and pressures within the microfluidic device 140 become stable so that the intended cell concentration behavior of the microfluidic device 140 is maintained as designed/desired. For example, the cell 730 is able to flow within the entire length of the central channel 610 along flow path 722, without being pushed into either side channel 660A/660B, thereby producing an accurate sorting result.

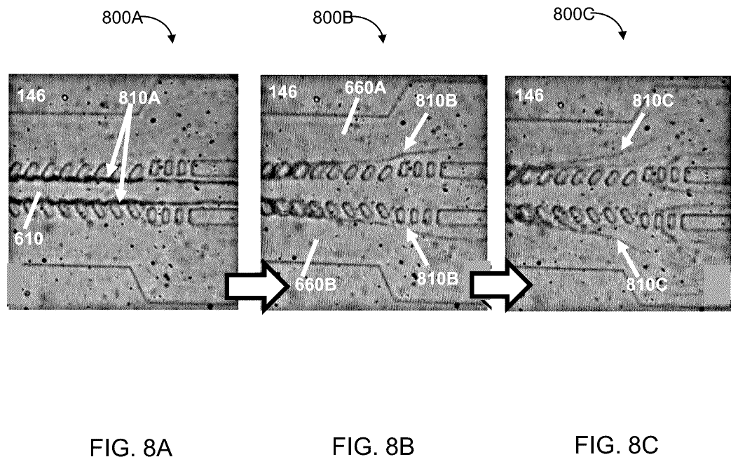

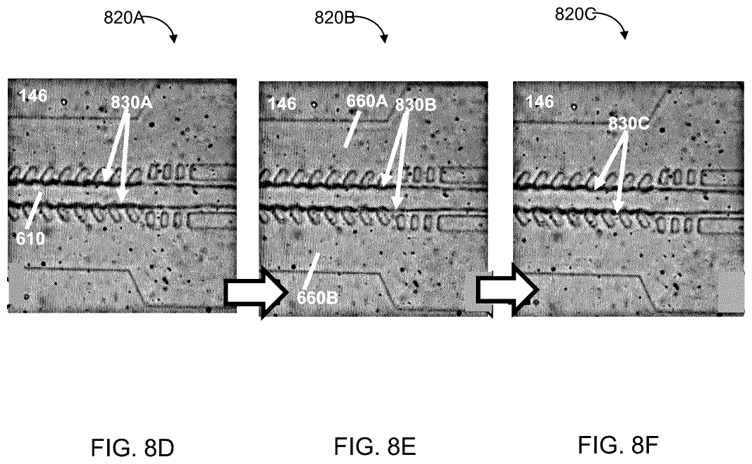

FIGS. 8A-8C are frames 800A-800C from a video illustrating flow lines 810A-810C of cells in a portion 146 of the microfluidic device 140 without the passive dampener device 130 of the present disclosure. The structure and operation of the microfluidic device 140 is meant to have separate fluidic streamlines for large cells and small cells and it is not intended to have large cells be moved out of the central channel 610 during operation. The pressure fluctuations within the microfluidic device 140 in an undampened system push the flow lines 810A-810C of large cells that had built up in the central channel 610 of the microfluidic device 140 into the side channels 660 of the portion 146 of the microfluidic device 140, which causes an error in sorting. For example, as shown in FIGS. 8A-8C, a frame 800A shows that the flow line 810A of large cells is within the central channel 610. A frame 800B subsequent to the frame 800A shows that the flow line 810B of large cells indicates that a portion of the large cells move out from the central channel 610 and move into the side channels 660A and 660B. A frame 800C subsequent to the frame 800B show that the flow line 810C of large cells indicates that a portion of the large cells move out from the central channel 610, into the side channel 660A and 660B, and then back into central channel 610.

FIGS. 8D-8F are frames 820A-820C from a video illustrating flow lines 830A-830C of cells in a portion 146 of the microfluidic device 140 with the passive dampener device 130 of the present disclosure. When the passive dampener device 130 (shown in FIGS. 1-5) is inserted into a flow path between the pump 120 and the microfluidic device 140 as taught herein, the pressure fluctuations are significantly reduced, the streamlines within 830A-830C the portion 146 of the microfluidic device 140 are maintained in their desired positions, and the intended cell separation performance of the microfluidic device is consistent. For example, as shown in FIGS. 8D-8F, a frame 820A shows that the flow line 830A of large cells is within the central channel 610. A frame 820B subsequent to the frame 820A shows that the flow line 830B of large cells is maintained within the central channel 610 without moving out from the central channel 610 and into the side channel 660A and 660B. A frame 820C subsequent to the frame 820B shows that the flow line 830C of large cells is still maintained within the central channel 610. The large cells are able to flow exclusively within the entire length of the central channel 610 to give an accurate sorting result.

It should be understood that the operations and processes described above and illustrated in the figures can be carried out or performed in any suitable order as desired in various implementations. Additionally, in certain implementations, at least a portion of the operations can be carried out in parallel. Furthermore, in certain implementations, less than or more than the operations described can be performed.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes multiple system elements, device components or method steps, those elements, components or steps may be replaced with a single element, component or step. Likewise, a single element, component or step may be replaced with multiple elements, components or steps that serve the same purpose. Moreover, while example embodiments have been shown and described with references to particular embodiments thereof, those of ordinary skill in the art will understand that various substitutions and alterations in form and detail may be made therein without departing from the scope of the present disclosure. Further still, other embodiments, functions and advantages are also within the scope of the present disclosure.

What is claimed is:

1. A passive pressure wave dampener system comprising:
a passive dampener device having a chamber to hold a fluid, the passive dampener device fluidically coupleable to a pump and a microfluidic device, the chamber having an air headspace to dampen pressure waves created by the pump in a sample fluid flow through the microfluidic device.

2. The passive pressure wave dampener system of claim 1, further comprises:
an input reservoir for holding a sample fluid;
the pump fluidically coupled to the input reservoir, the pump causing the sample fluid flow through the passive pressure wave dampener system; and
the microfluidic device configured to process particles/cells of interest within the sample fluid flow.

3. The passive pressure wave dampener system of claim 1, wherein the passive dampener device is disposed downstream of the pump and upstream of the microfluidic device.

4. The passive pressure wave dampener system of claim 2, wherein the chamber is disposed in an orientation such that air bubbles pulled from the input reservoir, or generated, by the pump and driven toward an inlet of the microfluidic device flow up into the chamber due to gravity rather than entering the microfluidic device.

5. The passive pressure wave dampener system of claim 1, wherein the chamber is filled with a priming and/or sample fluid until the chamber reaches a steady state at which the maximum value of the fluctuating pressure in the chamber matches the maximum pressure created by the pump.

6. The passive pressure wave dampener system of claim 5, wherein the sample is directed into the microfluidic device instead of into the pressurized chamber.

7. The passive pressure wave dampener system of claim 5, wherein two or more outlets of the microfluidic device are occluded to allow a resulting increase in pressure within the passive pressure wave dampener system to raise the air solubility of the priming or sample fluid, thereby increasing the dissolution rate of air that had been trapped within the microfluidic device.

8. The passive pressure wave dampener system of claim 1, wherein the chamber is disposed in an orientation such that the pressurized fluid in the chamber acts to push residual particles or cells through the microfluidic device when the sample from the input reservoir is no longer being actively pumped through the microfluidic device.

9. The passive pressure wave dampener system of claim 1, wherein a total volume of the chamber is calculated based at least in part on a type of the pump, a pressure range of the pressure wave produced by the pump, a fraction of the chamber that is filled, and a volume per a periodic pulse generated by the pump.

10. The passive pressure wave dampener system of claim 1, wherein the passive pressure wave dampener system is a fully, or functionally, closed system.

11. The passive pressure wave dampener system of claim 1, wherein the passive dampener device is external to the pump and microfluidic device.

12. The passive pressure wave dampener system of claim 1, wherein the passive dampener device further includes a connector having a first connection in fluidic communication with the pump, a second connection in fluidic communication with a port of the chamber, and a third connection in fluidic communication with an inlet of the microfluidic device.

13. The passive pressure wave dampener system of claim 1, wherein the pump is a peristaltic pump.

14. The passive pressure wave dampener system of claim 2, further comprising a second input reservoir for holding a priming fluid.

15. The passive pressure wave dampener system of claim 1, wherein the microfluidic device comprises:
an inlet;
two or more outlets;
one or more flow paths extending longitudinally from the inlet toward one of the two or more outlets, each flow path containing a central channel extending to a central channel output;
a plurality of micro-features adjacent to each central channel, the plurality of micro-features defining a plurality of gaps, the plurality of micro-features separating the central channel from at least one side channel, the plurality of gaps configured to fluidically couple the central channel to the at least one side channel, the at least one side channel extending along each central channel to at least one side channel output,
wherein the passive dampener device dampens the pressure waves such that an intended portion of the sample to be sorted in each central channel is maintained within each central channel along the entirety of the one or more flow paths.

16. The passive pressure wave dampener system of claim 1, wherein the sample is a blood cell sample.

17. The passive pressure wave dampener system of claim 16, wherein the microfluidic device is configured to separate and sort the blood cell sample into a collection of red blood cells and/or platelets, a collection of lymphocyte cells, and a collection of granulocyte cells and/or monocyte cells.

18. A method for dampening a pressure wave to smoothen a pulsatile fluid flow in a microfluidic device, the method comprising:
pumping, via a pump, a sample from an input reservoir to form a sample fluid flow;
dampening, via a passive dampener device, pressure waves induced in the sample fluid flow by the pump; and
introducing the sample fluid flow with dampened pressure waves to a microfluidic device for sample sorting.

19. The method of claim 18, further comprising automatically filling a chamber of the dampener device with a priming and/or sample fluid until the chamber reaches a steady state at which a maximum value of a fluctuating pressure within the chamber matches a maximum pressure created by the pump.

20. The method of claim 19, further comprising automatically releasing the priming fluid in the chamber to flush residual particles or cells from the dead volume of the microfluidic device and into one or more downstream output collection vessels, when the sample is no longer being actively pumped through the microfluidic device.
